(19) United States
(12) Patent Application Publication
(10) Pub. No.: US 2002/0094175 A1
(43) Pub. Date: Jul. 18, 2002

(54) Alignment of optical assemblies

(75) Inventor: Vilhelm Oskarsson, Jarfalla (SE)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor AB, Jarfalla (SE)

(21) Appl. No.: 10/027,588

(22) Filed: Dec. 20, 2001

(30) Foreign Application Priority Data
Dec. 22, 2000 (GB) 0031625.7

(51) Int. Cl. G02B 6/42; G02B 6/26

(52) U.S. Cl. 385/88; 385/52

(57) ABSTRACT

A method and system for use in accurately aligning components in a multi element electro-optic assembly. One or more guiding pins are provided in association with one layer of the assembly. Each remaining layer is provided with cooperating guiding means which mate with the guide pins in a manner whereby the various optical components are accurately aligned upon completion of the fabrication process. The system and method reduces the assembly time required by the typical time consuming active alignment technique.

This invention relates to multi-element, optical assemblies and more particularly to systems and method of accurately aligning elements during fabrication of an optical assembly.

Electro-optical interface devices such as optical transmitters and optical receivers have played an important role in the rapid growth of high speed, short and long range communications. Semi-conducting light emitting devices such as surface and edge emitting diodes and lasers can be tailored to generate optical power in a frequency range well suited to conventional photo diodes and optical fibers. In a exemplary implementation, a vertical cavity surface emitting laser (VCSEL), for example, is used to generate modulated optical power which is coupled into a single mode optical fiber and transported to a down stream receiver where the optical power is coupled to a photo diode and converted back to an electric signal. Typically, such VCSELs are mounted on a carrier, printed circuit board or a lead frame. In some applications a lens may be used to focus the optical beam onto the optical fiber. Alignment of such components is extremely critical, particularly in view of the very small size of the VCSEL and optical fiber. Misalignment by even small amounts severely reduces the coupling efficiency.

A frequently used fabrication technique for optical assemblies involves an active alignment process whereby the light emitting device is energized and the lens and fiber are moved relative to the active device until optimum coupling is accomplished. This process can be extremely time consuming and thereby adds considerably to the fabrication cost of the optical assembly.

Therefore, there exists a need for a system and method whereby the various components of the assembly can be accurately aligned in a efficient manner.

The present invention addresses the above discussed need by providing one or more of a variety of guide pins, which typically will be associated with one of the optical components for example, the substrate on which the active device is mounted, and then each of the remaining elements of the assembly will have a cooperating alignment means such that when each of the elements are aligned relative to the guide pin each of the components in the assembly are accurately aligned.

Therefore, in accordance with a first aspect of the present invention there is provided a method of aligning elements in the fabrication of a multi-element electro-optical assembly comprising: providing an alignment guide; and providing each element of the multi-element assembly with cooperating guide means whereby the positioning of the cooperating guide means on each element relative to the alignment guide provide alignment of the elements.

In accordance with the second aspect of the invention there is provided a system for use in aligning elements during the fabrication of an electro-optical assembly, each element having one or more components of the electro-optical assembly, the assembly comprising an alignment element and cooperating guide means associated with each element of the assembly whereby aligning the guiding means and the alignment element provides alignment of components of the assembly.

The invention will be described in greater detail with reference to the attached drawings wherein:

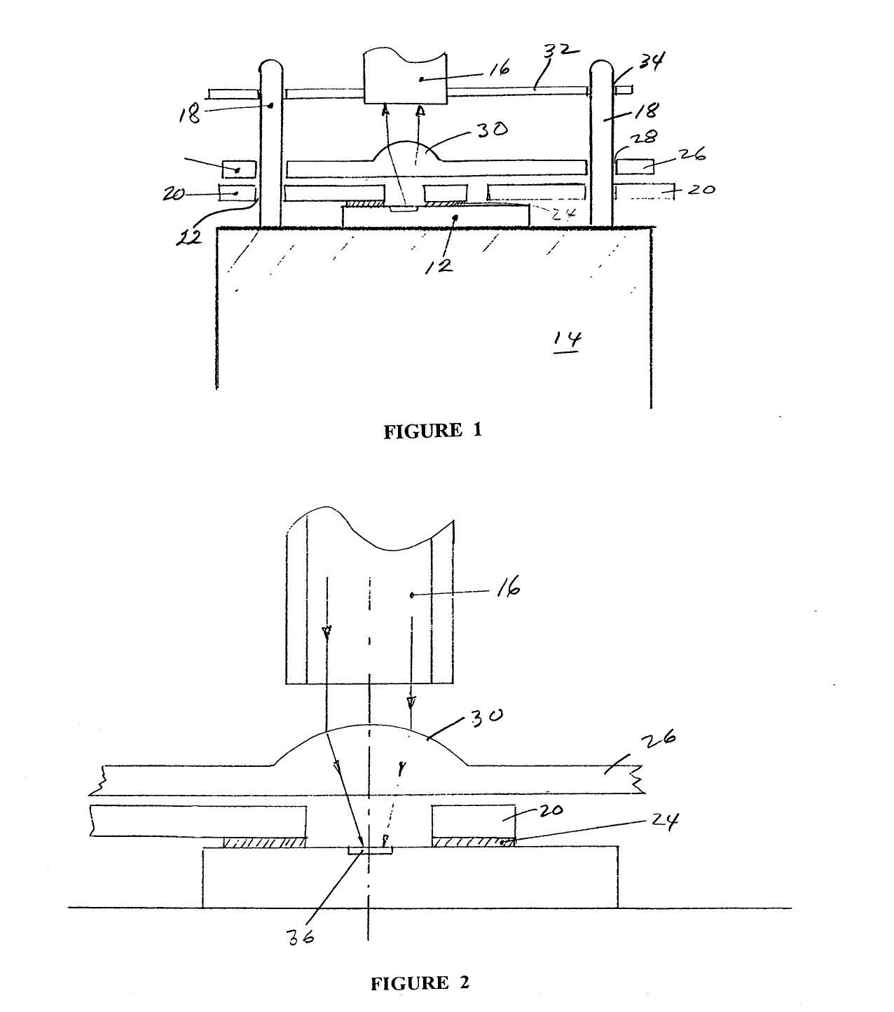

FIG. 1 is a side view of an optical assembly having a light emitting active device;

FIG. 2 is an enlarged partial view of an assembly having an optical receiver;

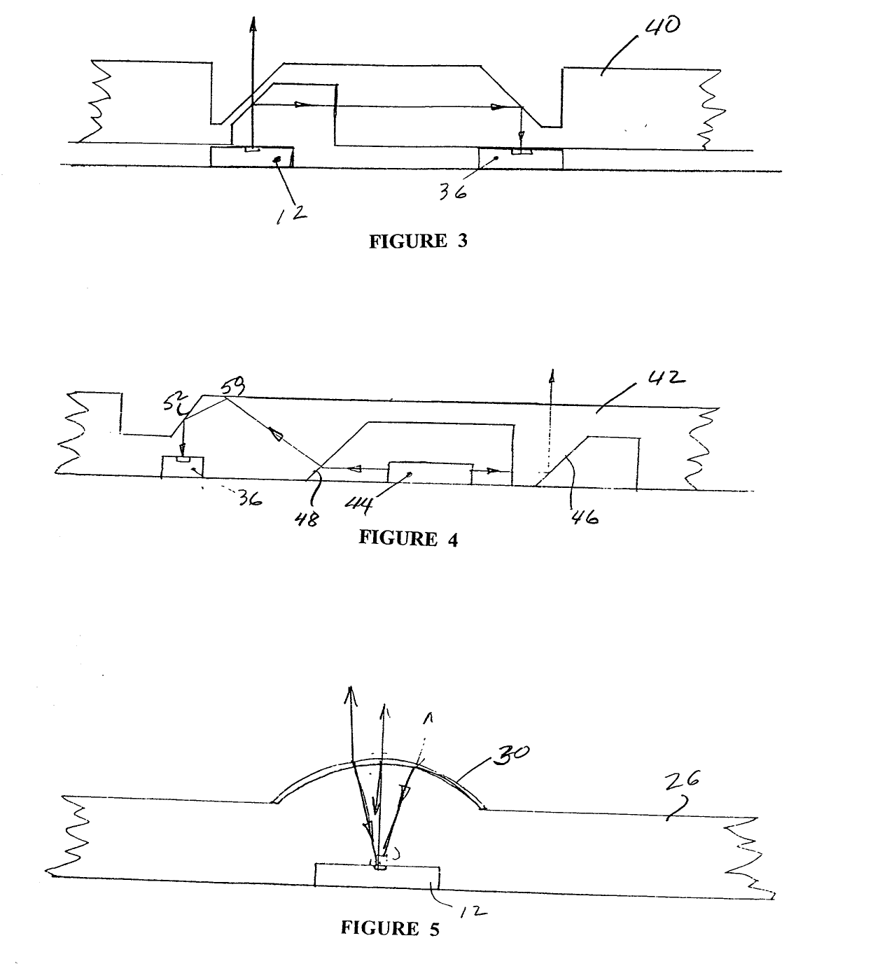

FIG. 3 is a side view of a transmitter and monitor assembly;

FIG. 4 is a side view of a variation of the assembly of FIG. 3;

FIG. 5 is a partial view of an assembly with a partially reflective lens; and

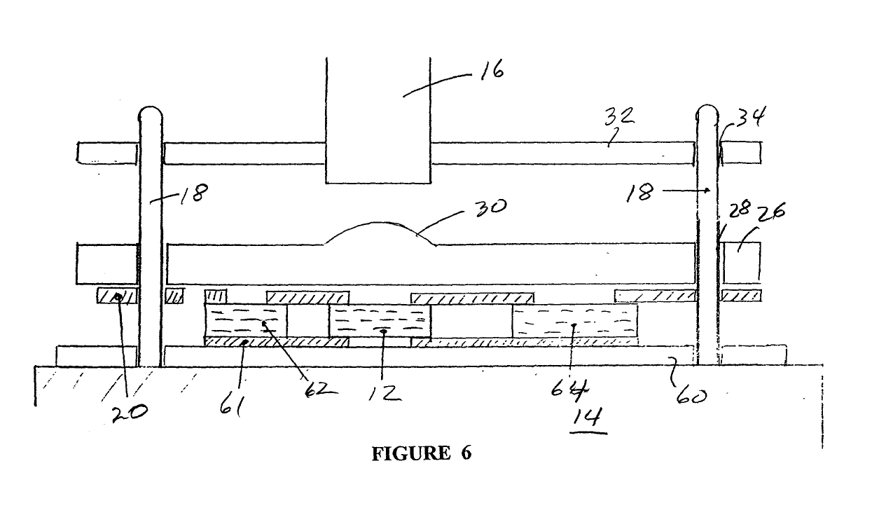

FIG. 6 is a cross sectional view of an optical assembly including associated integrated circuits.

FIG. 1 illustrates one practical embodiment of the present invention wherein a light emitting device such as VCSEL 12 is mounted on a substrate 14 or other suitable carrier and the output of the VCSEL is coupled into optical fiber 16. In FIG. 1 the substrate 14 has associated with it one or more guide pins 18. The VCSEL 12 may be positioned on the substrate 14 using an alignment marker (not shown), on the substrate such that the VCSEL is accurately positioned relative to guide pins 18. In FIG. 1 a lead frame 20 is used to make the necessary electrical connections to at least one side of the VCSEL 12. Lead frame 20 is provided with alignment guide means 22 which as shown in FIG. 1 is a hole of a suitable diameter to allow the lead frame 20 to drop over the guide pins 18. It is to be understood that VCSEL 12 can also be fabricated to use a flip chip type of construction wherein both electrical contacts are on the same side and may be attached to the lead frame 20 using solder 24. The lead frame 20 is placed over the guide pins 18 and in this case it is not necessary to provide any alignment marking on the substrate.

Lens assembly 26 is also provided with guide means 28 in the form of accurately positioned holes. The bubble lens 30 associated with lens assembly 26 is positioned relative to the guide means 28 such that when the lens assembly is mounted on the guide pins 18 the bubble lens 30 is directly over the active or light emitting region of the VCSEL 12. Finally, optical fiber 16 is held in a support member 32 which again is provided with guide means 34 such that when the fiber support is positioned over the guide pins 18 the fiber 16 is accurately aligned with respect to the lens 30 and the active portion of the VCSEL 12.

Guide pins 18 of FIG. 1 may be circular in cross section, square in cross section or in fact conical. Further, although the guide pins are seen to be associated with the substrate 14 it will be apparent to one skilled in the art that they may be associated with any of the other components of the assembly. For example, the pins may be part of the lens holder 26 in which case they will fit in to the appropriate holes in the remaining elements. The pins may be made of metal such as aluminum, an accurately etched semiconductor material, ceramic, plastic or other materials as will be apparent to one skilled in the art.

Although the guiding means are shown as being holes through the respective elements it will be also understood that these may simply be appropriately contoured forms such as grooves in the edges of the various elements of the assembly.

The guide pins 18 may also be in the form of balls, hook type devices or clips which, as indicated above, may be permanently associated with one of the elements or they may be of a type which may be removed after the assembly is completed and appropriately secured in place.

FIG. 2 shows a device similar to that which is shown in FIG. 1 except that it now comprises an optical receiver 36 such as a photo diode. In this implementation optical energy from a downstream source (not shown) is coupled from the optical fiber 16 through lens 30 and onto the active receptor 36. As in the previous aspect each of the components is aligned relative to each other by using the guide pins 18 which are not shown in FIG. 2.

FIGS. 3 and 4 illustrate application wherein the alignment of the lens assembly relative to active devices is critical. In FIG. 3 the relative output of VCSEL 12 is monitored by a photo detector 36 by reflecting a portion of the VCSEL output back to the detector using reflective surfaces of the accurately positioned lens 40.

FIG. 4 is another example of a lens assembly 42 wherein the optical transmission of an edge emitting device 44 is reflected out of the assembly by the 45 degree surface 46 of the lens 42. The emission from the back facet of the edge emitting device 44 is deflected by surface 48, and reflected by surfaces 50 and 52 to the detector 36. Again, the lens assembly 42 must be accurately positioned with respect to the emitter 44 and monitor 36 and this accurate positioning can be achieved using the alignment process of the present invention.

FIG. 5 shows a further example wherein the lens assembly has a partially reflecting surface such that a portion of the emission is returned to a suitably positioned detector.

FIG. 6 shows a further version of the assembly of FIG. 1. In this case a printed circuit board 60, has conductor rails 61 for attachment of various active components positioned relative to the guiding means 18. These components may be for example a VCSEL 12 (or a photo diode for example a PIN diode), pre and/or post amplifiers 62, drive chips 64, capacitors etc.

It will be apparent to one skilled in the art that the basic concept of the present invention will lend itself to the fabrication of a variety of assemblies wherein components on one layer must be accurately aligned relative to components on layers above and/or below. Such elements might include in addition to the above mentioned components, one or several ways to combine/split multiple wave lengths. The layers may also include mechanical or environmental protection covers to protect against moist, dust etc. The optical elements may include in additional to a lens, mirrors, anti-reflective coatings or other optical layers or fibers.

Although the particular embodiments of the invention have been described and illustrated it would be apparent to one skilled in the art that various changes can be made to these embodiments without departing from the underlining concept of the invention. It is to be understood that such variations will follow within the full scope of the invention as defined in the appended claims.

I claim:

1. A method of aligning elements in the fabrication of a multi-element electro-optical assembly comprising:
providing an alignment guide; and
providing each element of the multi-element assembly with co-operating guide means whereby the positioning of the co-operating guide means on each element relative to the alignment guide provides alignment of the elements.

2. The method according to claim 1 wherein each element includes a component of the electro-optical assembly.

3. The method according to claim 2 wherein said alignment guide is a guide pin.

4. The method according to claim 3 wherein said guide pin is formed integrally with one of the elements of the multi-element assembly.

5. The method according to claim 4 wherein said guide pin is formed integrally with a mounting substrate having an active device located thereon, said active device being aligned with respect to said guide pin.

6. The method according to claim 4 wherein said elements of the multi-element assembly include; a substrate having an active device, a lead frame, a lens, and a optical fiber support.

7. The method according to claim 3 wherein said guide pin is one of; a square cross section, a round cross section and conical.

8. The method according to claim 3 wherein said guide pin is removed after said electro-optical assembly has been fabricated.

9. The method according to claim 1 wherein said co-operating guiding means is a hole in each of said elements.

10. The method according to claim 1 wherein said co-operating guide means is a shaped edge of each of said elements.

11. A system for use in aligning elements during the fabrication of an electro-optical assembly, each element having one or more component of the electro-optical assembly, the system comprising;
an alignment element; and
co-operating guiding means associated with each element of said assembly, whereby aligning said guiding means and said alignment element provides alignment of components of said assembly.

12. A system as defined in claim 11 having at least two alignment elements.

13. A system as defined in claim 11 wherein said components comprise one or more of the following; an active semi-conductor device, a carrier, a lead frame, a lens, and an optical fiber.

14. A system as defined in claim 11 wherein respective components are positioned in association with respective elements relative to said guiding means such that said components are aligned in an assembled state.

15. A system as defined in claim 14 wherein said alignment element is a guide pin located in one of said elements.
